(19) United States
(12) Patent Application Publication
(10) Pub. No.: US 2026/0264629 A1
(43) Pub. Date: Sep. 10, 2026

(54) SOUND ABSORBING AND SOUND INSULATING AUTOMOTIVE NOISE ATTENUATING TRIM PART

(71) Applicant: AUTONEUM MANAGEMENT AG, Winterthur (CH)

(72) Inventors: Raphael MERRIEN, Winterthur (CH); Tommaso DELPERO, Zürich (CH); Théophane COURTOIS, Zürich (CH)

(73) Assignee: AUTONEUM MANAGEMENT AG, Winterthur (CH)

(21) Appl. No.: 19/168,214

(22) PCT Filed: Apr. 5, 2024
(86) PCT No.: PCT/EP2024/059277

§ 371 Date: Sep. 23, 2025

(30) Foreign Application Priority Data
Apr. 6, 2023 (EP) 23167068.8

(51) Int. Cl. B60R 13/08; B32B 5/02; B60R 13/02

(52) U.S. Cl. CPC B60R 13/0815; B32B 5/022; B60R 13/02; B32B 2262/0284; B32B 2307/102; B32B 2307/718; B32B 2307/7376; B32B 2605/003

(57) ABSTRACT

The invention concerns an automotive sound attenuating trim part featuring both sound insulating and sound absorbing capabilities. The trim part has mass spring characteristics, thus comprising a spring layer and a mass layer. The mass layer consists of a barrier layer and a porous fibrous layer adjacent to each other and laminated together with the barrier layer between the spring layer and the porous fibrous layer, wherein the mass layer has a radiation frequency of at least 3 kHz and a sound absorption average of at least 0.40.

This application is a national stage application under 35 U.S.C. 371 and claims the benefit of PCT Application No. PCT/EP2024/059277 having an international filing date of Apr. 5, 2024, which designated the United States, which PCT application claimed the benefit of European Patent Application No. EP23167068.8, filed Apr. 6, 2023, the disclosure of each of which are incorporated by reference herein.

### TECHNICAL FIELD

The present invention relates to the field of automotive trim components installed in the interior and/or on the exterior of a road vehicle for improving passenger acoustic comfort.

### BACKGROUND ART

In a road vehicle there are several sources of noise, which may radiate noise over a very broad frequency range, typically at least from 100 Hz to 10 kHz. This may cause discomfort to passengers, as this frequency range covers much of the audible frequency range.

Noise attenuating trim parts for improving passenger acoustic comfort in road vehicles are known in the art. These parts may be fitted onto vehicle body panels, in such a way to cover at least a part of the surface of these same panels. An example of such a noise attenuating trim part is the dash inner insulator, generally fitted onto the firewall of a vehicle body and substantially covering its entire surface. In other cases, noise attenuating trim parts may not be fitted onto a vehicle body panel but-rather-directly onto a noise source, covering at least a part of it. An example of such a noise attenuating trim part is an engine top cover, typically installed directly on a vehicle engine and covering its upper area.

Both the above-mentioned examples are directed to parts primarily aimed at attenuating the noise radiated by the powertrain. In a road vehicle, however, several noise attenuating trim parts addressing other sources of noise may generally be found. Examples are carpet insulators and wheel-house inner insulators, mainly intended to attenuate the noise radiated by the tires.

Noise attenuating trim parts may fulfil their function thanks to their sound absorption and/or sound insulation capabilities. Sound insulation refers to the ability of a noise attenuating trim part to reflect back the acoustic energy carried by the acoustic waves impinging on it. Sound absorption refers to the ability of a sound attenuating trim part to dissipate internally the acoustic energy carried by the acoustic waves impinging on it.

Both sound absorption and sound insulation contribute to the acoustic effectiveness of a noise attenuating trim part, when installed in a road vehicle. It is thus desirable that a noise attenuating trim part has both sound insulating and sound absorbing capabilities. However, the contribution of sound insulation and/or sound absorption to the acoustic effectiveness of a sound attenuating trim part may depend on the frequency.

Typically the contribution of sound insulation to the in-vehicle acoustic effectiveness of a noise attenuating trim part is important only on the frequency range up to about 3 kHz, in particular in the frequency range between 800 Hz and 3 kHz. Above 3 kHz flanking paths that may not be intercepted by noise attenuating trim parts installed either on vehicle body panels and/or around sources of noise may contribute in a relevant way to the transmission of noise into the passenger compartment of a road vehicle. On the other hand the contribution of sound absorption to the acoustic effectiveness of a noise attenuating trim part is generally important only above about 800 Hz. Sound absorption of a noise attenuation trim part below 800 Hz is generally small because packaging constraints generally limit the thickness of sound attenuating trim parts. The frequency range between 800 Hz and 3 kHz is a frequency range where both sound insulation and sound absorption may be important for the effectiveness of a noise attenuating trim part, when this is installed in a vehicle.

An example of a noise attenuating trim part with both sound insulating and sound absorbing capabilities is disclosed in EP2684187. In particular, this document discloses a noise attenuating trim part comprising a sound insulating area and a sound absorbing area. The sound insulating area has good sound insulating capabilities. On the other hand, the sound absorbing area has good sound absorbing capabilities.

More specifically, according to the disclosure of EP2684187, the sound insulating area has acoustic mass-spring characteristics and it comprises a decoupling layer and a mass layer, wherein the mass layer is realized by means of a porous fibrous layer backed by a barrier layer. In the sound insulating area, the porous fibrous layer is compressed to have a compressional dynamic Young's modulus of at least

$$118 \cdot {T}_{p} \cdot \frac{{AW}_{b} \cdot {AW}_{p} + \frac{{AW}_{p}^{2}}{4}}{{AW}_{b} + {AW}_{p}}$$

whereby Tₚ is the thickness of the porous fibrous layer in mm, AWₚ is the area weight of the porous fibrous layer in g/m² and AW_{b} is the area weight of the barrier in g/m². On the other hand, the sound absorbing area comprises at least a portion of the same porous fibrous layer of the sound insulating area, however the thickness of the portion of the porous fibrous layer in the absorbing area is larger than the thickness of the portion of the porous fibrous layer in the insulating area.

While it is true that a noise attenuating trim part like that disclosed in EP2684187 may combine sound insulation and sound absorption capabilities, the way in which this combination is realized in it is not optimal and it poses also some practical problems.

First of all, in such a part the sound insulating area has poor or no sound absorption capabilities, because in the sound insulating area the porous fibrous layer must be heavily compressed in order to achieve the desired compressional dynamic Young's modulus. At the same time, in such a part the sound absorbing area has poor or no sound insulation capabilities because in the sound absorption area the porous fibrous layer must be thickened in order to achieve the desired absorption performance and thus, even in combination with the backing barrier layer, it may not behave as a mass layer. As a consequence, in a noise attenuating trim part according to EP2684187 the sound insulation area and the sound absorption area are separate, with the sound insulation area having poor or no sound absorption capabilities and the sound absorption area having poor or no sound insulation capabilities. This fact necessarily limits the acoustic effectiveness of the part when installed in the vehicle.

In addition to this, the realization of noise attenuating trim part according to EP2684187 may require a porous fibrous layer with variable thickness, which makes the design of the part, its production process and the required tooling complex and expensive.

It is thus the purpose of the present invention to provide a solution to these problems of the state of the art. Thanks to the invention herein provided, it is possible to obtain a noise attenuating trim part that optimally combines sound insulation and sound absorption and that may be designed and manufactured in a simple and cost effective way.

### SUMMARY OF INVENTION

The object of the invention is achieved by a noise attenuating trim part according to claim 1 and a manufacturing process according to claim 14.

In its main aspect, the invention concerns a sound attenuating trim part comprising at least one area with mass-spring characteristics comprising a spring layer and a mass layer. In the sound attenuating trim part according to the invention, the mass layer consists of a barrier layer and a porous fibrous layer adjacent to each other and laminated together, with the barrier layer between the spring layer and the porous fibrous layer. Furthermore, in the sound attenuating trim part according to the invention, the mass layer has a radiation frequency of at least 3 kHz and a sound absorption average of at least 0.40.

Surprisingly, it was found that the acoustic effectiveness of a sound attenuating trim part according to the invention is strongly enhanced-compared to prior art solutions-thanks to the fact that it comprises at least one area that provides both excellent sound insulation and excellent sound absorption capabilities. The excellent sound insulation capabilities of this area derive from its mass-spring characteristics, combined with a mass layer having a radiation frequency of at least 3 kHz. At the same time, its excellent sound absorption capabilities derive from having a sound absorption average of at least 0.40. A part according to the invention represents a substantial advancement compared to prior-art solutions, wherein sound absorption capabilities and sound insulation capabilities are confined to separate areas of the part and are not combined in the same area of the part, a fact that limits the acoustic effectiveness of these prior-art solutions.

The “radiation frequency” of a mass layer consisting of a barrier layer and of a porous fibrous layer adjacent to each other and laminated together is a specific frequency that may be evaluated using the formula

$${F}_{r} = \frac{1}{2 π} \sqrt{\frac{\frac{{E}_{p}}{{T}_{p}} ( {AW}_{b} + {AW}_{p} )}{\frac{{AW}_{b} \cdot {AW}_{p}}{3} + \frac{{AW}_{p}^{2}}{12}}}$$

wherein AWₚ is the area weight in kg/m² of the porous fibrous layer, AW_{b} is the area weight in kg/m² of the barrier layer, Tₚ is the thickness in m of the porous fibrous layer and Ep is the compressional dynamic Young's modulus of the porous fibrous layer in Pa. As it is clear from the formula, the radiation frequency of a mass layer consisting of a barrier layer and a porous fibrous layer adjacent to each other and laminated together depends only on the physical properties of these same layers and it does not depend on the physical properties of other layers of a sound attenuating trim part comprising the mass layer.

At the radiation frequency, a mass layer consisting of a porous fibrous layer and a barrier layer adjacent to each other and laminated together may radiate noise very efficiently and this may impair the noise insulation of a sound attenuating trim part having mass-spring characteristics and comprising such mass layer, in particular at the radiation frequency of the mass-layer, as well as in a frequency range around it.

Herein, a “layer” is a body consisting of one or more materials and comprised between two closely spaced surfaces, wherein the distance between the surfaces is substantially smaller than their dimensions. The two surfaces are indicated as the “sides” of the layer and they are opposite to each other. The distance between the two surfaces is indicated as the thickness of the layer, which may be variable. In particular, a “barrier layer” is a layer that is air-tight or air-impervious, i.e. that does not allow air to move in our out of it.

In the mass-layer according to the invention, the radiation frequency is advantageously above 3 kHz, in a range where a deterioration of the sound insulation capabilities of the noise attenuating trim part according to the invention has limited impact on its acoustic effectiveness. In fact, above 3 kHz the transmission of noise into the passenger compartment of a road vehicle is typically strongly influenced by flanking paths that may not be intercepted by noise attenuating trim parts installed either on vehicle body panels and/or around noise sources and this limits the relevance of sound insulation for the acoustic effectiveness of a sound attenuating trim part when installed in a vehicle.

The compressional dynamic Young's modulus is intended to be measured in the direction of the thickness of the porous fibrous layer, hereafter referred to as “out-of-plane” direction. The out-of-plane compressional dynamic Young's modulus of the porous fibrous layer may be measured using the commercially available “Elwis-S” system. It is noticed that the out-of-plane compressional dynamic Young's modulus of a porous fibrous layer does not depend on frequency. Thus, it may be obtained with sufficient engineering accuracy by measuring it at any frequency. Preferably, it is obtained by averaging over a range of frequencies, for example between 300 Hz and 700 Hz, in order to compensate for the inevitable small variations with frequency, due to inaccuracies in the measurement process.

The compressional dynamic Young's modulus of the porous fibrous layer may be measured by extracting one or more samples of the same porous fibrous layer from an area or from areas of the sound attenuating trim part where this same part is reasonably flat. Standard tests with the Elwis-S system are carried out on circular samples having a diameter of 100 mm. However, in case it is not possible to extract a reasonably flat sample with such a diameter from a sound attenuating trim part, the test can be conducted also on samples with a smaller diameter. Preferably, the diameter of the sample should be at least 60 mm.

In addition, the load mass used for the Elwis-S tests should be such to guarantee that the sample under test is properly loaded and evenly excited over all its surface. For the execution of the tests with a standard circular sample having a diameter of 100 mm, a load mass comprised between 800 grams and 1300 grams is preferably used. For the execution of the tests with a circular sample having a different diameter, the top load mass should be rescaled based on the sample surface.

The sound absorption average of a sound-absorbing layer or multilayer is the frequency-average of its absorption coefficient between 800 Hz and 6.3 kHz, being the absorption coefficient measured according to ISO 10534-2:1998 and expressed in third-octaves. It was found that this quantity is particularly suitable to define the impact that the sound absorption capability of a trim part may have on its acoustic effectiveness when it is installed on the car. This may relate to the fact that the indicated frequency range is the one where the human ear is sensitive the most according to the A-weighting curve customarily used in acoustics to account for the human ear sensitivity. In fact, it is within this frequency range that the A-weighting curve has a level above about-1 dB.

In particular, for the mass layer according to the invention the sound absorption average is advantageously of at least 0.4, which guarantees that, over the frequency range where the human ear is sensitive the most, the acoustic absorption of the sound attenuating trim part according to the invention may contribute to the in-vehicle acoustic effectiveness of the same part in a substantial way, differently from what happens in prior-art noise attenuating trim parts.

The sound absorption average of the mass layer may be measured by extracting one or more samples of the same porous fibrous layer from an area or from areas of the sound attenuating trim part where this same part is reasonably flat. Standard measurements of the sound absorption average are carried out on samples having diameter 60 mm and 29 mm. Normally it is not a problem to find an area or areas on a sound attenuating trim part that are reasonably flat and from which one may extract samples of this size. Sound absorption average of the mass layer is meant to be measured from the side of the porous fibrous layer.

As it appears from all the above, the mass layer according to the invention combines features that confer at least to one area of the sound attenuating trim part according to the invention an optimal combination of sound insulation and sound absorption capabilities, able to substantially enhance the in-vehicle acoustic effectiveness of this same trim part compared to state of the art solutions.

This is obtained thanks to the at least one area with mass-spring characteristics comprising a spring layer and a mass layer, wherein the mass layer consists of a barrier layer and a porous fibrous layer adjacent to each other with the barrier layer between the spring layer and the porous fibrous layer, wherein the mass layer has a radiation frequency of at least 3 kHz and the porous fibrous layer has a sound absorption average of at least 0.40. In order to further enhance the acoustic effectiveness of the sound attenuating trim part according to the invention, preferably, said at least one area covers at least 50%, more preferably at least 70% and even more preferably at least 85% of the surface of the trim part according to the invention. Increasing the coverage ratio of said at least one area leads in fact to an improvement of the in-vehicle acoustic effectiveness of the sound attenuating trim part according to the invention.

The mass layer according to the invention consists of a porous fibrous layer and a barrier layer adjacent to each other. The porous fibrous layer according to the invention may be very light and thin, which is advantageous since this helps limiting the weight of the trim part according to the invention as well as the packaging space needed for it. Preferably, the porous fibrous layer according to the invention has an area weight between 500 g/m² and 2000 g/m², more preferably between 800 g/m² and 1800 g/m² and even more preferably between 1000 g/m² and 1500 g/m2. In addition, the thickness of the porous fibrous layer according to the invention is preferably between 2 mm and 10 mm, more preferably between 3 mm and 8 mm, even more preferably between 4 mm and 7 mm.

Furthermore, the density of the porous fibrous layer according to the invention is preferably between 100 kg/m³ and 600 kg/m³, more preferably between 200 kg/m3 and 400 kg/m3, even more preferably between 250 kg/m³ and 350 kg/m³. The higher is the density of the porous fibrous layer according to the invention, the higher is its compressional dynamic Young's modulus and thus its radiation frequency. Thus, porous fibrous layers with high density are desirable. However, increasing the density of the porous fibrous layer, besides increasing the weight of the sound attenuating trim part according to the invention, may make its production more difficult, since it leads to a substantial increase of the force needed to compress the porous fibrous layer.

The area weight and the thickness of the porous fibrous layer according to the invention may vary over its surface, provided this does not impair the essential features of the mass layer according to the invention. However, preferably the porous fibrous layer according to the invention has a substantially constant thickness and a substantially constant area weight over all its surface. This may be advantageous, because a porous fibrous layer with substantially constant area weight and thickness simplifies the design and the production process of the sound attenuating trim part according to the invention and it requires less expensive tooling. Here, by “substantially constant” it is meant that the thickness and/or the area weight of the porous fibrous layer may vary from point to point by an amount that corresponds to typical production tolerances and that does not impact the essential characteristics of the mass layer according to the invention. For example, a porous fibrous layer with a thickness that varies over its surface by 10% or less from its average value, e.g. 5.0 mm+/−0.5 mm, can be considered as having a substantially constant thickness, since such thickness variation corresponds to typical production tolerances and it has a minor impact both on the radiation frequency of the mass layer according to the invention and on the sound absorption average of the same porous fibrous layer according to the invention. Similarly, and always for example and for the same reasons, a porous fibrous layer having an area weight that varies over its surface by less than 5% from its average value, e.g. 1500 g/m²+/−75 g/m², may be considered as having a substantially constant area weight.

The porous fibrous layer may comprise any kind of natural and/or synthetic fibers common in the industry. Examples of natural fibers are cotton, wool, flax, hemp, bamboo, sisal, jute, and abaca fibers. Examples of synthetic fibers are polypropylene fibers, polyethylene fibers, polyester fibers, for instance polyethylene-terephthalate (PET) fibers, polylactic acid (PLA) fibers and polyamide (PA) fibers, in particular polyamide 6 or polyamide 6.6 fibers. Synthetic fibers may be mono-component or bicomponent fibers. Mono-component fibers are made from a single material, while bicomponent fibers are synthetic fibers made from two polymers of different chemical and/or physical structure that are tightly connected to each other along the fiber length. Bicomponent fibers may be produced using processes known in the art, e.g. by melt spinning. The porous fibrous layer may consist of only one single kind of fibers but it may also be a mix of fibers of different kinds.

Advantageously, the fibers of the porous fibrous layer according to the invention may be at least partially of a recycled nature, in order to reduce the environmental impact of the manufacturing process of the sound attenuating trim part according to the invention, for what concerns specifically material consumption. In particular, the fibers of the porous fibrous layer may at least partially be in the form of a natural fiber shoddy, for example a cotton shoddy, or in the form of a synthetic fiber shoddy, for example a polyester shoddy. A type-of-fiber-shoddy is defined as comprising at least 51% by weight of recycled fibers of the concerned material. So for instance, a cotton shoddy contains at least 51% by weight of recycled cotton fibers, being the remaining 49% by weight constituted by fibers of a different material and/or by virgin fibers. Preferably, the porous fibrous layer according to the invention comprises at least 50% by weight, more preferably at least 65% by weight and even more preferably at least 80% by weight of fibers in the form of a natural fiber shoddy and/or in the form of a synthetic fiber shoddy.

Furthermore, the porous fibrous layer according to the invention preferably comprises a binder, in an amount preferably comprised between 10% and 50% by weight, even more preferably comprised between 20% and 40% by weight. The binder may be of a thermoset or of a thermoplastic nature. In both cases, some kind of thermal treatment is needed in order to activate it. Thanks to the binder, during the production process of the sound attenuating trim part according to the invention the fibers of the porous fibrous layer may be firmly bonded together along their whole length at the same time as the trim part is being molded into the desired shape. This kind of bonding process ensures that, at the end of the process, the porous fibrous layer retains the desired shape stably and durably. A thermoset binder is preferable when enhanced mechanical properties and structural consistence are needed. On the other hand, a binder in the form of thermoplastic binder fibers is preferable when very complex 3-dimensional shapes have to be realized.

A thermoset binder is preferably in the form of an epoxy resin or a phenolic resin or a mixture of both. A thermoplastic binder is preferably in the form of thermoplastic binder fibers. These are fibers comprising at least one portion which melts as a result of a thermal treatment, forming droplets that bind all the other fibers at their crossing/contact points. The melting temperature of the binder fibers (or the portion of the binder fibers that melts) must obviously be lower than that of all the other fibers (and of the portion of the binder fibers that possibly does not melt). Binder fibers may be mono-component or bicomponent fibers. Particularly preferred as thermoplastic binder fibers are thermoplastic bicomponent core-sheath binder fibers. Thermoplastic bicomponent core-sheath binder fibers are bicomponent fibers wherein one of the two components (the sheath) surrounds the other (the core). The sheath component is the part of the fiber that melts during thermal treatment as described above. Also in the bicomponent core-sheath binder fibers the first polymer is preferably polyethylene terephthalate (PET) or polybutylene terephthalate (PBT) and the second polymer is preferably a copolymer of polyethylene terephthalate (coPET) or a copolymer of polybutylene terephthalate (coPBT).

The fibers constituting the porous fibrous layer may be both staple fibers and endless fibers. This applies also to the case of thermoplastic binder fibers that may be comprised in the porous fibrous layer according to the invention. Staple fibers are fibers that, differently from endless filaments, come in discrete predefined lengths. In particular, staple fibers comprised in the porous fibrous layer preferably have a length comprised between 32 mm and 76 mm.

The fineness of the fibers constituting the porous fibrous layer is preferably between 0.5 denier and 10 denier, more preferably between 0.5 denier and 5 denier, even more preferably between 0.5 denier and 2 denier. For a given mass of porous fibrous material, finer fibers provide a better sound-absorption performance.

The manufacturing of the porous fibrous layer according to the invention is preferably carried out by first preparing a fibrous non-woven in the form of a soft mat and consisting of fibers in the desired fibrous composition—hereafter referred to as “semi-finished product” or simply “semi-finished”—and then compressing it under heat.

The production of the semi-finished may take place according to any process known in the art. Such process may comprise, in particular, a step for the formation of a fibrous web consisting of randomly oriented and unbound fibers in the desired composition and a step for the consolidation of this same fibrous web. Besides these two steps, the production of the semi-finished may also involve other steps such as—for example—carding and cross lapping, which may be considered in order to provide to the fibers forming the web specific preferred orientations.

The process step for the formation of the fibrous web consisting of randomly oriented and unbound fibers in the desired composition may occur by means of techniques known in the art such as—for example—air-laying, wet-laying, spun-laying, melt-blowing and electro-spinning. Primary purpose of this step consists in obtaining a mixture of randomly oriented unbound fibers with the desired composition, which is as homogeneous as possible.

The process step for the consolidation of the above-mentioned fibrous web may also occur by means of bonding techniques known in the art such as—for example—thermal bonding, chemical bonding, mechanical bonding or a combination thereof. Examples of thermal bonding are hot calendering and/or ultrasonic bonding. Examples of chemical bonding are resin/spray powder bonding and/or foam bonding. Examples of mechanical bonding are needle-punching and/or hydro-entanglement. The primary purpose of this step consists in loosely binding the fibers of the fibrous web in the semi-finished product to each other in such a way to just provide to the semi-finished itself the consistency required to handle it during the production process of the sound attenuating trim part according to the invention, maintaining though the semi-finished in the form of a soft mat. The partial, loose bonding of the fibers in the semi-finished is thus very different from the complete, firm bonding of the fibers that takes place during the production process of the sound attenuating trim part as described above.

However, and very surprisingly, it was found that the bonding technique used for the consolidation of the fibrous web in the semi-finished product may have an influence on the features of the porous fibrous layer according to the invention and resulting from the compression under heat of such semi-finished product.

Preferably, the consolidation process step of the semi-finished used for the production of the porous fibrous layer according to the invention includes at least one needle-punching step. Surprisingly, it was found that with a needle-punched semi-finished it may be possible to achieve the desired compressional dynamic Young's modulus for the porous fibrous layer by compressing it to a lesser extent, compared to the case in which other bonding techniques for the consolidation of the porous fibrous web of the semi-finished product are used. As a consequence, by using a needle-punched semi-finished for its production, the porous fibrous layer according to the invention may be more easily adjusted so that the mass layer according to the invention have at the same time a radiation frequency above 3 kHz and a sound absorption average of at least 0.4. In fact, a higher compressional dynamic Young's modulus of the porous fibrous layer generally favors a higher radiation frequency of the mass layer according to the invention and, at the same time, a larger thickness of the porous fibrous layer generally favors a higher absorption of the mass layer according to the invention.

In order to further enhance the above-mentioned advantageous effect, the stitch density of the needle-punched semi-finished used for the production of the porous fibrous layer according to the invention is of at least 35 strokes/cm², more preferably of at least 40 strokes/cm² and even more preferably of at least 50 strokes/cm²

Needle-punching process may be from just one side or from both sides of the semi-finished. In case it is from both sides, the above-mentioned stitch density is the total stitch density. Furthermore, the stitch density mentioned here above may be referred not only to the semi-finished used to produce the porous fibrous layer according to the invention by compression under heat, but also to this same porous fibrous layer. When compressed into the shape desired for the porous fibrous layer according to the invention, the semi-finished may be slightly stretched, however the stretching does not substantially change the stitch density expressed in strokes/cm². Thus, the stitch density may be evaluated also on the final porous fibrous layer.

It is important to remark that, while it is here considered preferable that the consolidation process step of the semi-finished used for the production of the porous fibrous layer according to the invention includes at least one needle-punching step, this is not strictly necessary for the execution of the invention. Other bonding techniques such as thermal bonding and/or chemical bonding may be used for the consolidation of the semi-finished, as known in the art.

In a first preferred embodiment of the porous fibrous layer according to the invention, the porous fibrous layer is obtained by compressing under heat an air-lay needle-punched semi-finished, i.e. a semi-finished wherein the web-formation step is carried out by means of an air-lay process and the web-consolidation step comprises a needle-punching process. Preferably, the stitch density of the needle-punching process is of at least 35 strokes/cm², more preferably of at least 40 strokes/cm² and even more preferably of at least 50 strokes/cm². Preferably, in this first embodiment of the porous fibrous layer, the semi-finished- and thus also the porous fibrous layer obtained from it-consists in a mix of cotton shoddy and thermoplastic bicomponent binder fibers. In this embodiment, the amount of cotton shoddy is preferably between 60% and 90% by weight, more preferably between 70% and 85% by weight and the amount of thermoplastic bicomponent binder fibers is preferably between 10% and 40% by weight, more preferably between 15% and 30% by weight. The thermoplastic bicomponent binder fibers are preferably PET/CoPET fibers.

This first preferred embodiment is advantageous at least in two respects. First of all, due to the presence of cotton shoddy in the fiber mix, it includes a high amount of recycled material, which reduces the CO₂ footprint of the sound attenuation trim part according to the invention, for what concerns in particular material consumption. Secondly, the semi-finished is obtained with a particularly simple process, which does not include any carding and/or cross-lapping. This makes the production of the semi-finished easy and affordable with relatively simple non-woven production lines.

In a second preferred embodiment, the porous fibrous layer according to the invention essentially consists of thermoplastic bicomponent filaments, consisting of a first polymer having a higher melting temperature and a second polymer having a lower melting temperature. The filaments have preferably a core-sheath configuration. However, also other configurations known in the art such as the “side-by-side” configuration or the “islands-in-the-sea” configuration are possible. Filaments, hereafter called also “endless filaments”, are continuous fibers with indefinite length, i.e. not cut to a specific length like staple fibers. In this preferred embodiment, the porous fibrous layer according to the invention is preferably obtained by processing and compressing under heat a semi-finished consisting in a spun-laid, carded and cross-lapped fibrous web, subsequently consolidated by means of a needle-punching process.

In a thermoplastic bicomponent filament, the second polymer has a melting point lower than the melting point of the first polymer so that upon heating the bicomponent fibers, the first and second polymers react differently. When the bicomponent filaments are heated to a temperature that is above the softening or melting point of the second polymer (e.g. the sheath polymer, in a sheath-core configuration) and below the melting point of the first polymer (e.g. the core polymer, in a sheath-core configuration), the second polymer will soften or melt while the first polymer will not. A softening of the second polymer will cause the second polymer to become sticky and bond to filaments that may be in close proximity. At the same time, a melting of the second polymer will cause the formation of droplets binding adjacent fibers at their crossing points, while the first polymer stays intact and forms a network of solid, endless filaments in the final porous fibrous layer.

In this embodiment, the porous fibrous layer according to the invention has excellent mechanical properties, deriving from the synergy between the endless nature and the bicomponent nature of the filaments. On one hand, endless filaments span the whole surface of the porous fibrous layer. On the other hand, the melting of the second polymer guarantees the formation of bonding points between the endless filaments, bonding points that are uniformly distributed along the whole length of the filaments themselves. The result is a network of endless filaments spanning the whole surface of the porous fibrous layer according to the invention and strongly linked to each other. Such a network has excellent mechanical properties, in particular in terms of bending stiffness. The amount of the second polymer is preferably between 10% and 50% by weight relative to the weight of the porous fibrous structural layer, more preferably between 20% and 40% by weight relative to the weight of the porous fibrous structural layer, in order to improve the bonding between the filaments.

Thanks to its excellent mechanical properties, this second embodiment of the porous fibrous layer may be particularly suitable for applications wherein the sound attenuating trim part according to the invention may be subject to high levels of mechanical stress or vibration such as, for example, powertrain encapsulations, engine covers, trunk load floors, wheel-house outer liners.

In this embodiment, the porous fibrous layer according to the invention has preferably a bending modulus of at least 70 MPa, preferably between 70 MPa and 1300 MPa, preferably between 100 MPa and 950 MPa, preferably between 150 MPa and 700 MPa, measured according to ISO 178:2019 at 23 degrees Celsius and 50% relative humidity, in order not to deform in a substantial way under the effect of structural loads.

In a particularly preferred realization of this embodiment, the endless filaments consist of a terephthalate-based polyester. A porous fibrous layer essentially consisting of terephthalate-based polyester is advantageous for recycling. In this embodiment, the first polymer, i.e. the polymer with a higher melting point, is preferably polyethylene terephthalate (PET) or polybutylene terephthalate (PBT) and the second polymer, i.e. the polymer with a lower melting point, is preferably a copolymer of polyethylene terephthalate (coPET) or a copolymer of polybutylene terephthalate (coPBT). Always in this embodiment, at least a part of the polyester may advantageously be of a recycled nature. For example, the PET used as first polymer may be obtained from consumer products like PET bottle flakes or from PET packaging items or from PET marine products like fishing nets, by melting them and forming them into pellets that may be used for the spinning process. Using recycled polyester has the advantage of reducing the environmental impact of the manufacturing process of the water-shield according to the invention, in particular its CO₂ footprint. In this embodiment, preferably at least 20%, more preferably at least 50% and even more preferably at least 70% of the polyester used for the bicomponent fibers is recycled polyester, wherein the percentage is the weight percentage calculated in respect of the total weight of the porous fibrous structural layer.

When they consist of polyester, the diameter of the endless bicomponent filaments is preferably between 14 microns and 37 microns, more preferably between 20 microns and 25 microns, in order to achieve the required strength.

In a third preferred embodiment, the porous fibrous layer according to the invention essentially consists of a fibrous mixture comprising 20% to 50% by weight of PET monocomponent staple fibers, 20% to 50% by weight of thermoplastic bicomponent PET/CoPET binder staple fibers and 20% to 40% by weight of hollow-conjugate monocomponent PET fibers. In this preferred embodiment, the porous fibrous layer according to the invention is obtained by processing under heat a semi-finished consisting of an air-laid fibrous web having the above-mentioned fiber composition and consolidated by thermal bonding (e.g. by hot calendering).

Similarly to the above-described second preferred embodiment for the porous fibrous layer, also this third preferred embodiment is particularly advantageous in terms of recyclability, since it is 100% PET. In addition to this, the presence of hollow-conjugate fibers in the fiber mixture makes it particularly lightweight and enhances its sound absorption performance.

Similarly to what was previously described in relation to the second preferred embodiment for the porous fibrous layer, the PET of the different constituents of the fibrous mix may advantageously be of a recycled nature.

The mass layer according to the invention consists of the porous fibrous layer and the barrier layer adjacent to each other. The barrier layer may consist of any material or materials, provided it fulfils its primary function, which consists in acting as an acoustic barrier.

The area weight and the material of the barrier layer may be important features for the design of the sound attenuating trim part according to the invention. In fact, the area weight and the material of the barrier layer may advantageously be adjusted by the person skilled in the art to realize a desired trade-off between the weight of the sound attenuating trim part according to the invention and its sound insulation. A higher area weight of the barrier layer enhances the sound insulation of the sound attenuating trim part according to the invention, in particular in the frequency range between 800 Hz and 3 kHz. However, at the same time, it makes this same part heavier, which is disadvantageous for the fuel consumption and CO₂ emissions of the vehicle on which the part is eventually installed.

When a particularly lightweight sound attenuating trim part is desired, the area weight of the barrier layer is preferably between 10 g/m² and 200 g/m², more preferably between 50 g/m² and 150 g/m².

In this case, a preferred embodiment of the barrier layer according to the invention is a film of polymeric nature, preferably comprising at least one of the polymers or copolymers selected from the group consisting of polyesters such as polyethylene terephthalate (PET) or polybutylene terephthalate (PBT); polyamides such as polyamide 6 or polyamide 66; polyolefins such as polypropylene (PP), polyethylene (PE); thermoplastic elastomers (TPEs) such as thermoplastic polyolefin (TPO), thermoplastic polyurethane (TPU); elastomers such as EPDM-based elastomers or butadiene-based elastomers or silicones; high performance polymers such as polytetrafluoroethylene (PTFE), polyetherimide, polysulfone, polyethersulfone, polyetheretherketone (PEEK); ethylene vinyl acetate (EVA); biopolymers such as polylactic acid (PLA).

Preferably the material or materials used for the film and the material or materials used for the porous fibrous layer belong to the same chemical group, making recycling easier.

The film may be mono-layer, bi-layer or multi-layer. Bi-layer or multilayer films may be used to further increase stability, elasticity and/or robustness.

Always in this embodiment of the barrier layer according to the invention, the film has preferably a tensile strength at break higher than 20 MPa and a strain at break higher than 100%. In case the film is anisotropic, these values refer both to machine-direction and cross-direction. Stress and strain at break are measured according to ISO 527-1:2019 and 527-3:2018. In addition, the thickness of the film is preferably between 10 micrometers and 200 micrometers, more preferably between 50 micrometers and 150 micrometers.

On the other hand, when a sound attenuating trim part with a particularly enhanced sound insulation is desired, the area weight of the barrier layer is preferably between 500 g/m² and 8000 g/m², more preferably between 1500 g/m² and 5000 g/m² and even more preferably 2000 g/m² and 3500 g/m².

In this case, a preferred embodiment of the barrier layer according to the invention is a layer comprising a matrix of thermoplastic elastomeric material, mass-loaded with an inorganic filler. Such a layer is commonly referred to as “heavy layer” in the field, it is air-tight and it is thus suitable for acting as a barrier layer in the sound attenuating trim part according to the invention.

In this embodiment of the barrier layer according to the invention, the material or materials comprised in the thermoplastic elastomeric matrix are preferably selected from the group consisting of ethylene vinyl acetate copolymer (EVA); Ethylene Propylene Diene Monomer (EPDM); polyesters such as polyethylene terephthalate (PET) and/or polybuthylene therephthalate (PBT); poly-propylene (PP); polyethylene such as High Density Polyethylene (HDPE) and/or Low Density Polyethylene (LDPE) and/or Ultra High Molecular Weight Polyethylene (UHMWPE); Poly Vinyl Chloride (PVC); Poly Carbonate (PC); polyamide such as PA-4 and/or PA-6 and/or PA-66; Thermoplastic Polymide (TPI); Thermoplastic Polyolefin (TPO); Thermoplastic Polyurethane (TPU); Poly Tetra Fluoro Ethylene (PTFE); Poly Ether Ether Ketone (PEEK); Acrylonitrile Butadiene Styrene (ABS); Poly Methyl Metha Crylate (PMMA). The inorganic filler is preferably one of calcium carbonate (CaCO₃) and/or Barium Sulphate (BaSO₄). In addition, the amount of inorganic filler is preferably up to about 85% by weight.

Always in this embodiment of the barrier layer according to the invention, the thickness of the barrier layer is preferably between 0.2 mm and 5 mm, more preferably between 0.8 mm and 3 mm.

The choice of the barrier layer, in particular its area weight and material, may depend on the desired trade-off between sound insulation capabilities and overall weight of the sound attenuating trim part according to the invention. In addition, it may also depend on the material of the porous fibrous layer. Preferably, the material or materials of the barrier layer and the material or materials of the porous fibrous layer belong at least partially to the same chemical group. This facilitates the process of laminating the porous fibrous layer and the barrier layer together. In fact, for the sound attenuating trim part according to the invention to achieve the desired effect, it is essential that the barrier layer and the porous fibrous layer are adjacent to each other and they are laminated together. Here, by “laminated together”, it is meant that they are permanently assembled together in such a way to act together as a mass layer under the action of the acoustic waves impinging on the sound attenuating trim part according to the invention. The lamination process may take place by such means as, for example, heat and/or pressure and/or welding and/or an adhesive.

Besides the above-mentioned advantage in terms of lamination process, the fact that the material or materials of the barrier layer and the material or materials of the porous fibrous material layer belong at least partially to the same chemical group favors also end-of-life recyclability of the sound attenuating trim part according to the invention.

In the sound attenuating trim part according to the invention, the spring layer has the function to isolate the mass layer from the acoustic waves and/or vibrations of the noise source.

Preferably, the spring layer has a dynamic compressional Young's modulus not higher than 300 kPa, more preferably not higher than 150 kPa, even more preferably not higher than 80 kPa. In addition, the spring layer has a thickness preferably comprised between 1 mm and 80 mm, more preferably between 3 mm and 50 mm and even more preferably between 5 mm and 40 mm. In general, a lower dynamic compressional Young's modulus and a higher thickness may provide a better performance, i.e. the spring layer better isolates the mass layer from the acoustic waves and/or vibrations of the noise source. However, in practical cases thickness may be limited by design constraints such as packaging space or cost.

The dynamic compressional Young's modulus of the spring layer may be measured by means of the commercially available tool Elwis-S, in a way similar to what was previously described for the porous fibrous layer according to the invention. However, in the case of the spring layer, a load mass comprised between 150 grams and 400 grams is preferable for the Elwis-S tests. This value of the load mass is referred to the standard circular sample with a diameter of 100 mm. For samples with different dimensions, the load mass has to be rescaled as previously described.

In the sound attenuating trim part according to the invention, the spring layer may comprise any material, provided it fulfils the above-describe primary function. Preferably, it comprises porous materials and/or cellular materials, which is advantageous in terms of weight reduction.

In a first preferred embodiment, the spring layer according to the invention consists of a fibrous non-woven. In this embodiment, the fibrous materials used for the spring layer are essentially the same as those used for the porous fibrous layer according to the invention and previously described. However, the spring layer has preferably a lower density than the porous fibrous layer according to the invention, i.e. it is preferably loftier and less compressed, since this may enhance its isolation function against noise/vibration coming from the noise source. In this embodiment, the density of the spring layer is preferably between 30 kg/m³ and 300 kg/m³, more preferably between 40 kg/m³ and 200 kg/m³ and even more preferably between 50 kg/m³ and 150 kg/m³.

This first preferred embodiment of the spring layer according to the invention may offer advantages in terms of end-of-life recyclability of the sound attenuating trim part according to the invention, in particular when the material or materials of the spring layer belong to the same chemical group of the material or materials of the barrier layer and of the porous fibrous layer.

In a second preferred embodiment, the spring layer according to the invention consists of an open-cell foam, preferably a polyurethane foam. In this embodiment, the density of the foam is preferably between 30 kg/m³ and 200 kg/m², more preferably between 40 kg/m³ and 120 kg/m³ and even more preferably between 50 kg/m³ and 90 kg/m³. This realization of the spring layer may be advantageous as foams, and in particular polyurethane foams, offer excellent molding possibilities and greater design flexibility. This embodiment may therefore be advantageous if the sound-absorbing trim part according to the invention is to be fitted to a body panel and/or a noise source with a particularly complex three-dimensional shape.

All the above listed preferred embodiments for the porous fibrous layer, the barrier layer and the spring layer according to the invention may advantageously be combined by the person skilled in the art depending on the desired trade-off between in-vehicle acoustic effectiveness, weight, process complexity and design constraints.

For example, a mass layer according to the invention may be obtained by combining the above-described first preferred embodiment for the porous fibrous layer (consisting of an air-lay needle-punched porous fibrous layer comprising cotton shoddy and binder staple fibers) suitably adjusted so to have a radiation frequency above 3 kHz and a sound absorption average of at least 0.4, with a barrier layer consisting of an EPDM heavy layer. In turn, this mass layer according to the invention may be combined with a spring layer made of foam, obtaining an embodiment of the sound attenuating trim part according to the invention with excellent sound insulation capabilities and suitable for being installed on vehicle panels and/or noise sources with complex three-dimensional shapes.

Similarly, a mass layer according to the invention may be obtained by combining the previously described second preferred embodiment for the porous fibrous layer (consisting of thermoplastic bicomponent filaments, preferably PET thermoplastic bicomponent filaments) suitably adjusted so to have a radiation frequency above 3 kHz and a sound absorption average above 0.4 with a barrier layer consisting of a light PET film, e.g. a 50 g/m² PET film. In turn, this mass layer according to the invention may be combined with a spring layer made of PET staple fibers obtaining a sound attenuating trim part according to the invention which is excellent in terms of recyclability (being made 100% by PET) and lightweight.

These two examples represent just two of the many possibilities of combining the previously describe preferred embodiments for the porous fibrous layer, the barrier layer and the spring layer according to the invention. Other combinations may be envisaged by the person skilled in the art, depending on the circumstances of the case.

Furthermore, in order to enhance the acoustic effectiveness of the sound attenuating trim part according to the invention, a thin fibrous porous layer (commonly known in the field as “scrim”) or a micro-perforated polymeric foil with tuned Air Flow Resistivity (AFR) may be laminated at least on a part of the side of the porous fibrous layer that is opposite to the one along which the porous fibrous layer is adjacent to the barrier layer. In order to obtain the desired improvement of the acoustic properties of the sound attenuating trim part according to the invention, the AFR of the fibrous scrim or of the micro-perforated polymeric foil is preferably higher than that of the porous fibrous layer, more preferably at least 20% higher than that of the porous fibrous layer, in all areas where the fibrous scrim or micro-perforated film is applied. The fibrous scrim or the micro-perforated polymeric foil has preferably an area weight not higher than 400 g/m², more preferably not higher than 200 g/m², in order not to substantially increase the overall weight of the sound attenuating trim part according to the invention.

Preferably, the additional fibrous scrim or micro-perforated foil is made with material or materials belonging to the same chemical group of the material or materials constituting the porous fibrous structural layer, in such a way to favor recycling.

Always in order to further enhance in-vehicle acoustic effectiveness, the sound attenuating trim part according to the invention may further comprise one or more additional acoustic absorbers, located on the side of the porous fibrous layer opposite to the one along which it is adjacent to the barrier layer. Additional acoustic absorbers may comprise any kind of acoustically absorbing material known in the art, for example a fibrous material such as a textile non-woven or a felt or a cellular material such as an open cell foam, in particular a polyurethane foam. An additional acoustic absorber may be in the form of a layer comprising one or more acoustically absorbing materials. In this case, such additional acoustic absorber may be laminated together with the porous fibrous layer and it may be structurally connected to it by gluing and/or by stapling and/or by welding (e.g. ultrasound welding). Such an additional acoustic absorber may cover totally or partially the surface of the porous fibrous layer. Preferably, the additional acoustic absorber is made with material or materials belonging to the same chemical group of the material or materials constituting the porous fibrous layer, in such a way to favor recycling.

All the above mentioned means to enhance the in-vehicle acoustic effectiveness of the sound attenuating trim part according to the invention, i.e. the addition of a scrim and/or of a micro-perforated foil, and/or of an additional absorber may be combined as technically possible and known in the art. For example, a micro-perforated polymeric foil may be laminated at least on a part of the porous fibrous layer on the side opposite to that along which it is adjacent to the barrier layer and, furthermore, a layer of acoustically absorbing material may be added on top of the micro-perforated foil.

The sound attenuating trim part according to the invention may be manufactured using production processes known in the art.

A first production process, applicable to the case in which the spring layer is a fibrous layer, comprises at least the following steps:
(a1). a first fibrous non-woven layer, a barrier layer and a second fibrous non-woven layer are stacked on top of each other, with the first fibrous non-woven layer above the barrier layer and the barrier layer above the second fibrous non-woven layer;
(b1). the so-obtained multilayer is laid on the lower half-mold of a molding tool. The molding tool comprises a lower half-mold and an upper half-mold that, when the molding tool is closed, delimit a mold cavity having the three-dimensional shape desired for the sound attenuating trim part according to the invention;
(c1). the molding tool is closed and hot steam is injected into the mold cavity, from both the upper and from the lower half-molds, at approximately the same pressure, increasing from 0 bar to a maximum pressure preferably between about 5 bar and 6 bar. To perform this step, both the upper and the lower half-molds must be equipped with channels for injecting steam into the mold cavity;
(d1). after a time interval sufficient for the hot steam to cure the fibrous layers and make them adhere to the barrier layer, the steam is exhausted both through the upper half-mold and through the lower half-mold of the molding tool. For this exhaust operation, the same channels that are used in step (c1) to inject the steam into the molding tool cavity may be used;
(e1). vacuum is applied from the upper half-mold so to compress the first porous fibrous layer against the upper half-mold; (f1). the molding tool is opened and the molded part is taken out of it.

Additional steps may comprise cutting (e.g. in a shear-cutting tool) and cooling (e.g. in a cooling jig equipped with a cooling fan) the molded part.

In step (e1) of the above-described first production process, the compression of the first fibrous non-woven against the upper half-tool is such to confer to it the properties needed to realize, together with the barrier layer, a mass-layer according to the invention. In step (c1), both fibrous layers are cured thanks to the action of the hot steam and, always thanks to the action of the hot-steam, they adhere to the barrier layer. In order to favor this adhesion, before stacking the layers in step (a1) both sides of the barrier layer are preferably treated with an adhesive primer.

In a second production process, which is a variant of the first production process above described, step (e1) is replaced by step
(e2). hot steam is injected from the lower half-mold so to compress the first fibrous layer between the upper half tool and the barrier layer.

With this variant, it is possible to obtain a higher pressure to compress the first porous fibrous layer compared to the case of the first production process, which may be useful, for example, when the first porous fibrous layer has a high area weight.

In a third production process, which is again a variant of the first production process, step (e1) is skipped and step (c1) is replaced by step
(c3) hot steam is injected both from the upper half-mold and from the lower half-mold, wherein in a first phase the hot steam pressure is increased from 0 bar to a maximum value preferably in the range of 5 bar- to 6 bar and in a second phase the pressure is kept constant at this maximum value and wherein during the pressure increase phase the pressure of the hot steam injected from the lower half-mold is higher than that of the hot steam injected from the upper half-mold, by an amount preferably between 1 bar and 2 bar, in such a way to compress the first porous fibrous layer between the barrier layer and the upper half-mold, while curing the fibrous layers and making them adhere to the barrier layer.

With this variant, it is possible to reduce the number of process steps and to make the process less demanding in terms of energy consumption, compared to the case of the first and second production processes described above.

A fourth production process, which may be applied to the case in which the spring layer is a foam layer, comprises at least the following steps:
(a4) a first fibrous non-woven layer and a barrier layer are stacked on top of each other;
(b4) the so-obtained multilayer is laid on the lower half-mold of a first molding tool. The first molding tool consists of a lower half-mold and of an upper half-mold that, when the first molding tool is closed, delimit a first mold cavity having the three-dimensional shape desired for the mass layer according to the invention. Furthermore, both the lower and the upper half-molds are kept at a temperature sufficient to cure the first fibrous non-woven and make it adhere to the barrier layer, preferably at a temperature comprised between 160° C. and 200° C., even more preferably comprised between 160° C. and 180° C.
(c4) the first molding tool is closed and kept closed for a time interval sufficient to cure the first fibrous non-woven and make it adhere to the barrier layer. In this step, the first fibrous non-woven is also compressed in the first molding tool so to acquire the properties needed to realize, together with the barrier layer, a mass-layer according to the invention.
(d4) the molding tool is opened and the molded mass layer according to the invention is taken out of it;
(d5) the molded mass layer according to the invention is laid on the lower half-mold of a second molding tool, which is a foaming tool, i.e. a tool where a polyurethane foam precursor may be injected into the mold cavity through an injection head present in the upper half mold. The second molding tool comprises a lower half-mold and an upper half-mold that, when the first molding tool is closed, delimit a second mold cavity having the three-dimensional shape desired for the sound attenuating trim part according to the invention;
(d6) the second molding tool is closed and a polyurethane foam precursor is injected into the mold cavity;
(d7) after a time interval sufficient for the foam precursor to react, fill with polyurethane foam the volume of the mold cavity not occupied by the mass layer and adhere to the barrier layer, the second molding tool is opened;
(d8) the molded part is taken out of the mold.

In this fourth production process, the production of the sound attenuating trim part according to the invention is split in two macro-steps: the production of the mass layer according to the invention, which is carried out by means of hot-molding, and the addition of the spring layer. In the above described list of steps, the case in which the spring layer is a foam layer is considered. However, an obvious variant may be envisaged to apply a similar process also to the case of a fibrous spring layer, wherein the spring layer is, in the second macro-step, simply over-molded on top of the mass-layer.

The four production processes described here above for the production of the sound attenuating trim part according to the invention represent just examples. Further production processes, such as production processes based on cold-molding, may be envisaged by the person skilled in the art.

Furthermore, all the embodiments previously described for the sound attenuating trim part according to the invention represent just possible material arrangements to obtain this same sound attenuating part. By considering the features of the materials here described, in particular their nature, density, thickness and area weight, the person skilled in the art may derive from these embodiments further material arrangements that may be suitable depending on the circumstances.

In addition to this, further embodiments of the sound attenuating trim part according to the invention may be derived from the description also by combining the different embodiments and examples of the invention and may be also derived from the description of the embodiments shown in the figures. The figures are schematic and not necessarily in scale. All ranges disclosed include end-points.

### BRIEF DESCRIPTION OF DRAWINGS

FIG. 1a shows a sound attenuating trim part belonging to the state of the art and FIG. 1b shows a cross-section of such a part.

FIG. 2a shows a sound attenuating trim part according to the invention and FIG. 2b shows a cross-section of such a part.

FIG. 3 shows the comparison between the acoustic effectiveness of a sound attenuating trim part according to the invention and that of a sound attenuating trim part belonging to the state of the art.

### DETAILED DESCRIPTION

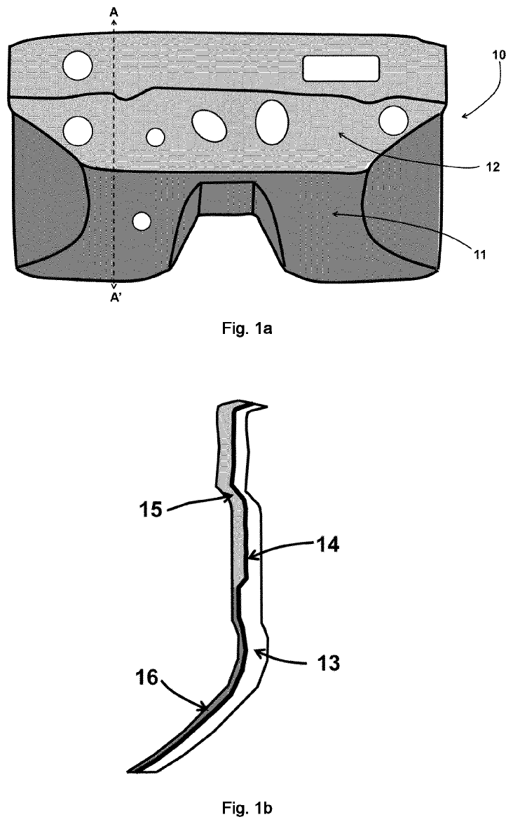

FIG. 1a shows an example of a typical sound attenuating trim part 10 belonging to the state of the art, namely a dash inner insulator wherein an insulating area 11 with predominantly sound insulation capabilities and a sound absorbing area 12 with predominantly sound absorption capabilities are present. In the sound attenuating trim part shown in FIG. 1a, the sound absorbing area 12 covers the upper part of the sound attenuating trim part 10 corresponding to approximately 60% of its total surface, while the sound insulating area 11 covers the lower part of the sound attenuating trim part 10, corresponding to approximately 40% of its total surface.

FIG. 1b shows a representative cross section A-A′ of the sound attenuating trim part 10 displayed in FIG. 1a. The sound attenuating trim part 10 comprises a spring layer 13, a barrier layer 14 and a porous fibrous layer (15,16). The porous fibrous layer (15,16) has a variable thickness. In the lower part 16 corresponding to the sound insulating area 11 it has an approximately constant thickness of about 3.8 mm, while in the upper part 15 corresponding to the sound absorbing area 12 it has an approximately constant thickness of about 7.0 mm. According to the state of the art teachings, the higher compression of the porous fibrous layer 16 in the sound insulating area is needed to confer to this area mass-spring characteristics and then good sound insulation capabilities; however this is very detrimental for the sound absorption in this same area. In the same way, the higher loftiness (i.e. lower compression) of the porous fibrous layer 15 in the sound absorbing area is needed to confer to this area higher sound absorption capabilities; however this is very detrimental for the sound insulation in this same area.

In the sound attenuating trim part 10 belonging to the state of the art, the porous fibrous layer (15,16) is obtained by compressing under heat an air-lay semi-finished with an area weight of about 1000 g/m² and consisting of approximately 75% of cotton shoddy and 25% of PET/CoPET core-sheath binder staple fibers. In this same part, the barrier layer 14 consists of an EVA heavy layer with a constant area weight of approximately 3.5 kg/m² and a constant thickness of approximately 1.9 mm. The spring layer 13 is obtained by compressing an air-lay semi-finished fibrous web with an area weight of about 1000 g/m² and consisting of approximately 80% of cotton shoddy and 20% of PET/CoPET core-sheet binder staple fibers. The overall area weight of the sound attenuating trim part 10 is thus about 5500 g/m².

The compressional dynamic Young's modulus of the porous fibrous layer (15,16) was measured and resulted in 413.5 kPa for the thickness of 3.8 mm corresponding to the porous fibrous layer 16 in the sound insulating area 11 and in about 120 kPa for the thickness of 7.0 mm corresponding to the porous fibrous layer 15 in the sound absorbing area 12. From these values it may be deduced that the radiation frequency corresponding to the mass layer in the sound insulating area 11 is about 3550 Hz, while the radiation frequency of the mass layer in the sound absorbing area 12 is about 1910 Hz, thus well below 3 kHz. According to the state of the art teachings, this strong lowering of the radiation frequency is a clear indication that the sound insulation in the sound absorbing area 12 is substantially lower than that in the sound insulating area 11, in particular in the frequency range around 2 kHz, which is a very relevant frequency range for interior noise in vehicle acoustics.

The sound absorption average of the mass layer was also measured, again for the two thickness values of the porous fibrous layer (15,16) of 3.8 mm and 7.0 mm corresponding—respectively—to the sound insulating area 11 and to the sound absorbing area 12. The sound absorption average of the mass layer in the sound insulating area 11 turned out to be 0.255, while that for the sound absorbing area resulted in 0.437. This shows that, consistently with the teachings of the prior art, compressing the porous fibrous layer in the sound insulating area 11 is very detrimental for the sound absorption in this same area.

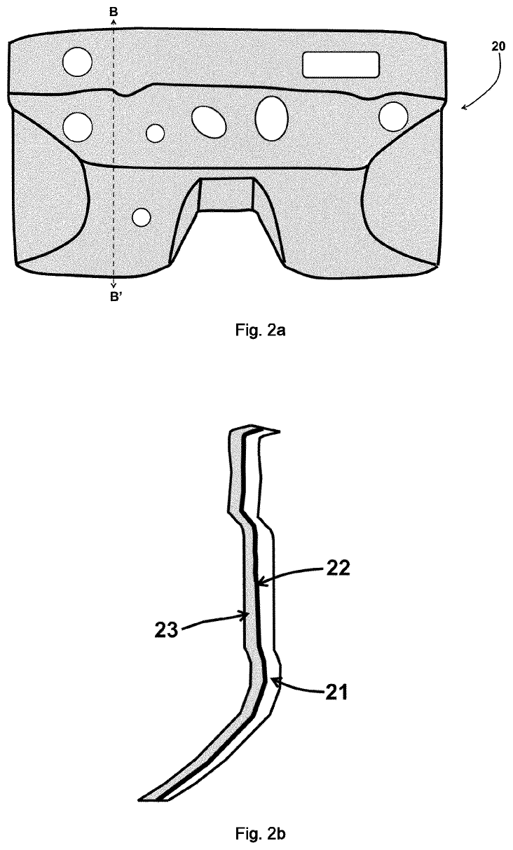

FIG. 2a shows a sound attenuating trim part 20 according to the invention. This is a dash inner insulator having the same overall shape as that shown in FIG. 1a, however without any distinction between a sound insulating area and a sound absorbing area.

FIG. 2b shows a representative cross section A-A′ of the sound attenuating trim part 20 displayed in FIG. 2a. The sound attenuating trim part 20 comprises a spring layer 21, a barrier layer 22 and a porous fibrous layer 23. The porous fibrous layer 23 has a substantially constant thickness of about 5.0 mm. In the sound attenuating trim part 20 according to the invention, the porous fibrous layer 23 is obtained by compressing under heat an air-lay needled semi-finished with an area weight of about 1500 g/m² and consisting of approximately 80% of cotton shoddy and 20% of PET/CoPET core-sheath binder staple fibers. In this case, the semi-finished used for the porous fibrous layer 23 was needled from both sides, with a total needling stitch density of about 55 strokes/cm². Always in the sound attenuating trim part 20 according to the invention, the barrier layer 22 consists of an EVA heavy layer with an area weight of about 3000 g/m² and a thickness of about 1.6 mm and the spring layer 21 is the same as that for the sound attenuating trim part 10 belonging to the state of the art. The overall area weight of the sound attenuating trim part 20 according to the invention is about 5500 g/m², thus the same as that of the sound attenuating trim part 10 belonging to the state of the art.

The compression dynamic Young's modulus of the porous fibrous layer 23 was measured and turned out to be about 832 kPa. This value was obtained by averaging over the results obtained for 5 samples. For each sample the test was conducted with a load mass of 1181 grams and an average over the frequency range between 300 Hz and 700 Hz was taken. From the above mentioned value of the dynamic compressional Young's modulus, it can be deduced that the radiation frequency of the mass layer of the sound attenuating trim part 20 is about 5 kHz, thus well above 3 kHz.

The sound absorption average of the mass layer (22,23) was measured and resulted equal to 0.40.

The acoustic effectiveness of the sound attenuating trim part 20 according to the invention was compared to that of the sound attenuating trim part 10 belonging to the state of the art. The acoustic effectiveness or noise reduction was calculated according to the procedure described, for example, in section 6.4 of Pierce, A., D., “Acoustics—An introduction to its Physical Principles and Applications”, McGraw-Hill Book Company, 1981. According to this procedure, the acoustic effectiveness or noise reduction of a sound attenuating trim part may be calculated by the formula:

$$NR = TL - 10 \cdot {Log}_{10} ( \frac{S}{A} )$$

where TL is the diffuse-field transmission loss of the trim part, ABS is its diffuse-field absorption area of the trim part expressed in m² and S is the surface area in of the same part, also expressed in m². In the case of the sound attenuating trim parts shown in FIGS. 1a and 2a this latter area is 1.33 m². As known in the art, the diffuse-field transmission loss corresponds to the value in dB of the transmission coefficient, with inverted sign.

The TL and the ABS of the sound attenuating trim part 20 according to the invention were obtained from tests on flat multilayers having the same layering as the part shown in FIGS. 2a and 2b both for what concerns materials utilized and the related area weights and thicknesses. TL was measured in the commercially available measurement system Isokell. ABS was measured in the commercially available measurement system Alpha Cabin. Both measurement systems are described in Chappuis, A., “Small Size Devices for Accurate Acoustical Measurements of Materials and Parts Used in Automobiles,” SAE Technical Paper 931266, 1993.

Similar tests were conducted to measure the TL and ABS of the sound insulating area 11 and of the sound absorbing area 12 of the sound attenuating trim part 10 belonging to the state of the art. The TL of the sound attenuating trim part 10 was obtained by a weighted average of the transmission coefficients of the two different areas 11 and 12, being the weight attributed to each area equal to the corresponding coverage fraction (which is 0.4 for the sound insulating area and 0.6 for the sound absorbing area, in the case of the sound attenuating trim part 10). A similar procedure was followed for the calculation of the ABS of the sound attenuating trim part 10 from the ABS values of the sound insulating area 11 and sound absorbing area 12.

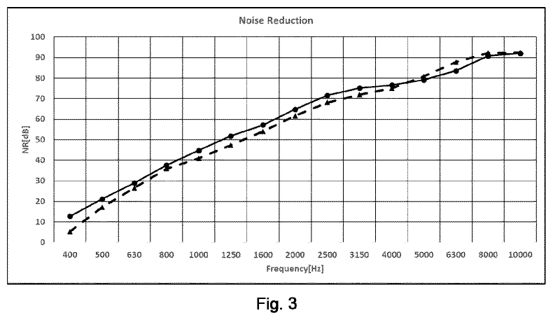

FIG. 3 shows, with a solid line, the acoustic effectiveness or noise reduction of the sound attenuating trim part 20 according to the invention. In the same FIG. 3, with a dashed line, the acoustic effectiveness or noise reduction of the sound attenuating trim part 10 belonging to the state of the art is shown. As one can see from this Figure, the overall improvement obtained with the sound absorbing trim part 20 according to the invention is clear and it covers a very large frequency range, in particular most of the frequency range between 800 Hz and 6300 Hz.

1. A sound attenuating trim part comprising at least one area with mass-spring characteristics comprising a spring layer and a mass layer, wherein the mass layer consists of a barrier layer and a porous fibrous layer adjacent to each other and laminated together with the barrier layer between the spring layer and the porous fibrous layer, characterized in that the mass layer has a radiation frequency of at least 3 kHz and the porous fibrous layer has a sound absorption average of at least 0.40.

2. The sound attenuating trim part according to claim 1, characterized in that the at least one area covers at least 50% of the surface of the sound attenuating trim part.

3. The sound attenuating trim part according to claim 1, characterized in that the thickness of the mass layer is substantially constant.

4. The sound attenuating trim part according to claim 1, characterized in that the porous fibrous layer is an air-lay needle-punched porous fibrous layer with a needling density of at least 35 strokes/cm².

5. The sound attenuating trim part according to claim 1, characterized in that the thickness of the porous fibrous layer is between 2 mm and 10 mm.

6. The sound attenuating trim part according to claim 1, characterized in that the area weight of the porous fibrous layer is between 500 gsm and 2000 gsm.

7. The sound attenuating trim part according to claim 1, characterized in that the barrier layer has an area weight between 10 g/m² and 200 g/m².

8. The sound attenuating trim part according to claim 1, characterized in that the barrier layer has an area weight between 500 g/m² and 8000 g/m².

9. The sound attenuating trim part according to claim 1, characterized in that the radiation frequency of the mass layer is at least 5000 Hz.

10. The sound attenuating trim part according to claim 1, characterized in that the porous fibrous layer comprises a natural fiber shoddy and a binder.

11. The sound attenuating trim part according to claim 1, characterized in that the porous fibrous layer comprises thermoplastic bicomponent filaments consisting of a first polymer with a higher melting temperature and a second polymer with a lower melting temperature.

12. The sound attenuating trim part according to claim 1, characterized in that the porous fibrous layer comprises fibers consisting of terephthalate-based polyester and a thermoplastic binder.

13. The sound attenuating trim part according to claim 1, wherein the spring layer, the barrier layer and the porous fibrous layer comprise materials belonging to the same chemical group, preferably materials belonging to the group of terephthalate-based polyesters.

14. A process for producing a sound attenuating trim part, comprising at least the following steps:
a first fibrous non-woven layer, a barrier layer and a second fibrous non-woven layer are stacked on top of each other, with the first fibrous non-woven layer above the barrier layer and the barrier layer above the second fibrous non-woven layer;
the obtained multilayer is laid on the lower half-mold of a moulding tool comprising an upper half-mold and a lower half-mold which, when closed, delimit a cavity having the shape desired for the noise attenuating trim part;
in order to cure the fibrous layers and make them adhere to the barrier layer, hot steam is injected into the moulding tool cavity both from the upper half-mold and from the lower half-mold, wherein the pressure of the hot steam injected both from the lower half-mold and from the upper half mold is first increased from 0 bar to a maximum value preferably comprised between 5 bar and 6 bar and then kept constant at this maximum value and wherein, during the pressure increase phase of the hot steam pressure, the pressure of the hot steam injected from the lower half-mold is higher than that of the steam injected from the upper half-mold, by an amount preferably comprised between 1 bar and 2 bar, so to compress the first porous fibrous layer between the barrier layer and the upper half-mold;
after a time interval sufficient for the hot steam to cure the fibrous layers and make them adhere to the barrier layer, the steam is exhausted both through the upper half-mold and through the lower half-mold of the molding tool; and
the moulding tool is opened and the molded part is taken out of it.
